(19) United States
(12) Patent Application Publication
(10) Pub. No.: US 2002/0078059 A1
(43) Pub. Date: Jun. 20, 2002

(54) Filling station system for free access to the internet

(76) Inventor: Marco Antonio Urera, Metro Manila (PH)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 09/949,286

(22) Filed: Sep. 7, 2001

Related U.S. Application Data
(60) Provisional application No. 60/230,853, filed on Sep. 7, 2000.
(60) Provisional application No. 60/267,940, filed on Feb. 9, 2001.

(51) Int. Cl. G06F 7/00

(52) U.S. Cl. 707/100

(57) ABSTRACT

Disclosed is a method for providing Internet access. Information about a user is received at a server, for example, a RADIUS server. The server searches a database for the information. If the information is found, an amount of free Internet access time is allocated to the user. The time that the user is accessing the Internet is tracked. Once the amount of free Internet access time is depleted, access to the Internet is discontinued. Options to increase the amount of free Internet access time by amounts of additional free Internet access time are provided. Software may be required to obtain the amounts of free or additional free Internet access time. An access card may be required to obtain the amounts of free or additional free Internet access time.

### CROSS-REFERENCE TO RELATED APPLICATIONS

This application claims the benefit of U.S. Provisional Patent Application Serial Nos. 60/230,853, filed Sep. 7, 2000 and 60/267,940, filed Feb. 9, 2001.

### BACKGROUND OF THE INVENTION

1. Field of the Invention

The present invention is directed to a method for accessing the Internet and, more particularly, to a method for providing free access to the Internet.

2. Description of Related Art

Present systems that purport to provide free Internet access time do not provide completely “free” time. These systems hide costs in telephone meters or toll charges or require purchase of items from particular sites. Other sites restrict the viewing portion of the computer screen such that specific advertisements are always present.

### SUMMARY OF THE INVENTION

It is an object of this invention to provide Internet access that is free to the user by having owners and/or promoters of web sites sponsor free online time for the user.

A Filling Station method for providing Internet access according to the present invention includes receiving at a server, for example, a RADIUS server, information about a user. The server searches a database for the information that includes an amount of free Internet access time for the user. If the information is found, the amount of free Internet access time is allocated to the user. The time and/or duration that the user is connected to the Internet is tracked. Once the amount of free time is depleted, access to the Internet is discontinued. Options may be provided to extend the amount of free Internet access time. The server contains, inter alia, the Filling Station system's database, access codes, and information on users' remaining free Internet access time.

A user may use a pre-set amount of free Internet access time by using Filling Station software installed on the user's computer. A connection to the server is made by using the Filling Station software. After the connection is made, the amount of free Internet access is made available to the user.

Additionally, a user may obtain an amount of free Internet access time through other methods besides using the Filling Station software. In a first method, after establishing a connection to the Internet using the user's own Internet Service Provider (ISP) or a pre-paid access card, a sponsor's web site is visited where access codes and an amount of free Internet access time may be obtained. The access codes may then be used by the user to establish a separate Internet connection to use the amount of free Internet access time. In a second method, the user may use information on an access card distributed by a sponsor (“Sponsored Access Card”) to dial in directly to the server and use an initial amount of free Internet access time. The user may use this initial amount to obtain additional free Internet access time by visiting a web site of the sponsor of the Sponsored Access Card.

An advantage of the Filling Station system is that the user is able to surf the Internet for free. Rather than pay an ISP for access, the user may opt to view web sites of selected sponsors in exchange for free Internet access time. Based on interests of the user, the system may provide links to sponsor web sites of interest to the user.

Another advantage of the Filling Station is that traffic to the sponsor's web site will be increased due to users wanting to gain free Internet access time. Providing an option to direct users to specific sponsors' web sites based on users' interests, the audience of a sponsor's web site is more likely to be what the sponsor is seeking and more likely to interact with the web site, thereby bringing more value to the sponsor.

By sponsoring minutes to be given to users, sponsors are given a tool to lead the Internet community to their web sites and are able to more effectively deliver their messages to their target audience through web media. Sponsors will also be able to gauge the effectiveness of their online efforts by uniquely identifying visitors through demographic data and how these visitors interact with their web site.

By providing the mechanism for web site sponsorships which include the Internet access of users, the system provides an alternative source of revenue for the free-ISP business model.

### BRIEF DESCRIPTION OF THE DRAWINGS

FIG. 1 is a block diagram illustrating a method for providing Internet access;

FIG. 2 is a screen shot illustration of a window when the Filling Station software is opened;

FIG. 3 is a screen shot illustration of a window of the Filling Station software which provides options for connecting to the Internet; and

FIG. 4 is a screen shot illustration of a browser window of the Filling Station software after connection to the Internet.

### DETAILED DESCRIPTION OF THE PREFERRED EMBODIMENTS

A complete understanding of the invention will be obtained from the following description when taken in connection with the accompanying drawings wherein like reference characters identify like parts throughout.

For purposes of the description hereinafter, the terms “upper”, “lower”, “right”, “left”, “vertical”, “horizontal”, “top”, “bottom”, and derivatives thereof shall relate to the invention as it is oriented in the drawing. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

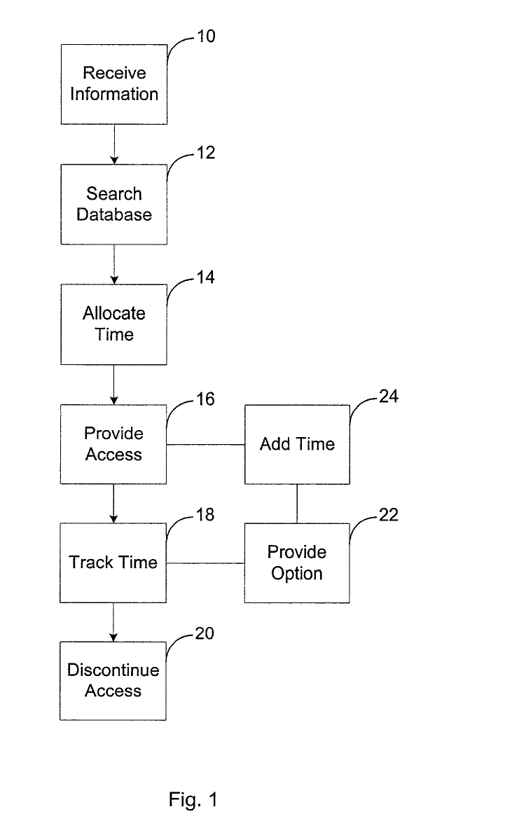

Referring to FIG. 1, a method for providing Internet access begins with the server receiving information about a user in step 10. The information, preferably, includes a username and password.

The server searches a database for the information in step 12. The database includes a list of user accounts including usernames and corresponding passwords. Additionally, an amount of free Internet access time is associated with each user account. If the information is found during the search of the database, the amount of free Internet access time associated with the user account is allocated to the user in step 14.

The server provides the user with access to the Internet for the amount of free Internet access time allocated to that user in step 16. The server tracks an amount of used time that the user is accessing the Internet in step 18. When the amount of used time equals the amount of free time, access to the Internet is discontinued in step 20.

One or more options to increase the amount of free time may be provided to the user prior to the discontinuation of the access to the Internet in step 22. If the user elects to use one or more of the options, an amount of additional free Internet access time is credited to the relevant user account in step 24.

The server may prompt the user when the amount of used time is nearing the amount of free time. The prompt may also provide an option to increase the amount of free time.

A preferred embodiment of a system for providing users with free access to the Internet according to the present invention includes Filling Station software, a server, sponsor web sites, an amount of free Internet access time, areas for obtaining an amount of additional free Internet access time, and a database. The system utilizes a Filling Station configuration to provide users with access to the Internet without access charges being posted to the user. In the Filling Station configuration, a user may “fill-up” with “fuel” while visiting a “filling station”. In other words, the user starts with a specified amount of free time to access the Internet, unless the user initially connects to the Internet through his own ISP or a pre-paid access card (discussed below). While visiting a sponsor's web site, the user may add an amount of free Internet access time to the user's current amount of free Internet access time to have a greater amount of free time for accessing the Internet.

The Filling Station software is an application that incorporates an e-mail application, a dialer, and a web browser. A sponsor is an owner and/or promoter of a web site that pays to sponsor free Internet access time for users in order to attract the users to the sponsor's web site. The database houses information necessary for operating the system and includes user accounts. Each user account includes a username, a password, and an amount of free Internet access time.

The Filling Station software is distributed to a user and installed on a computer connected to a telephone line. Once the Filling Station software is installed on the computer, the user may create a user profile (including username and password) within the Filling Station software or, after a connection to the server is established (discussed below), import an existing profile from the database. The profile stores information about the user, for example, the user's name, and system settings, for example, the dial-up number to be used for establishing the connection to the server.

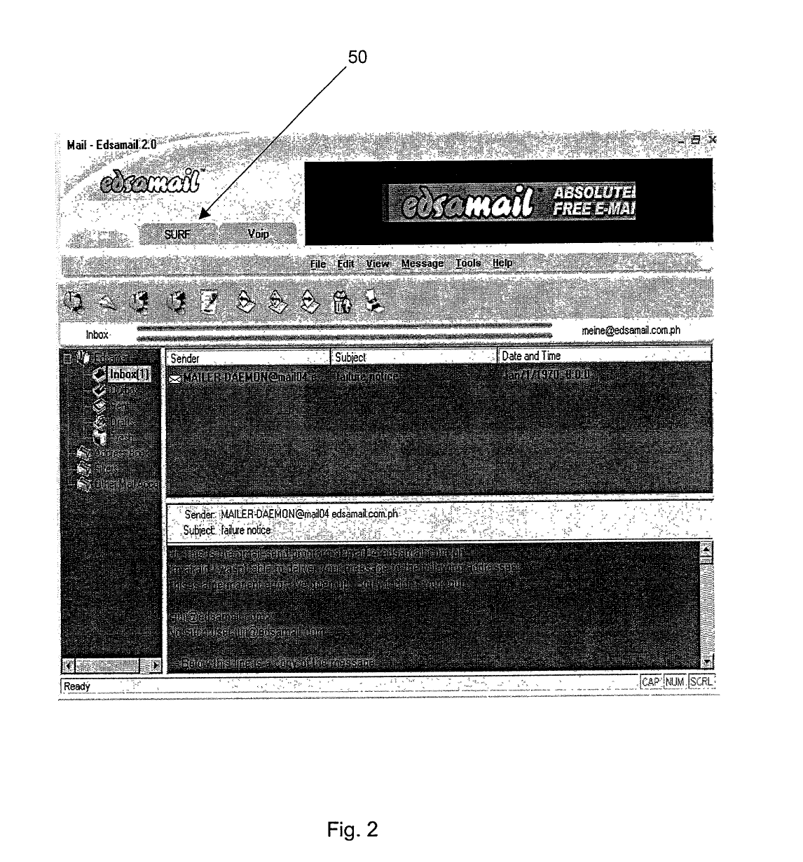

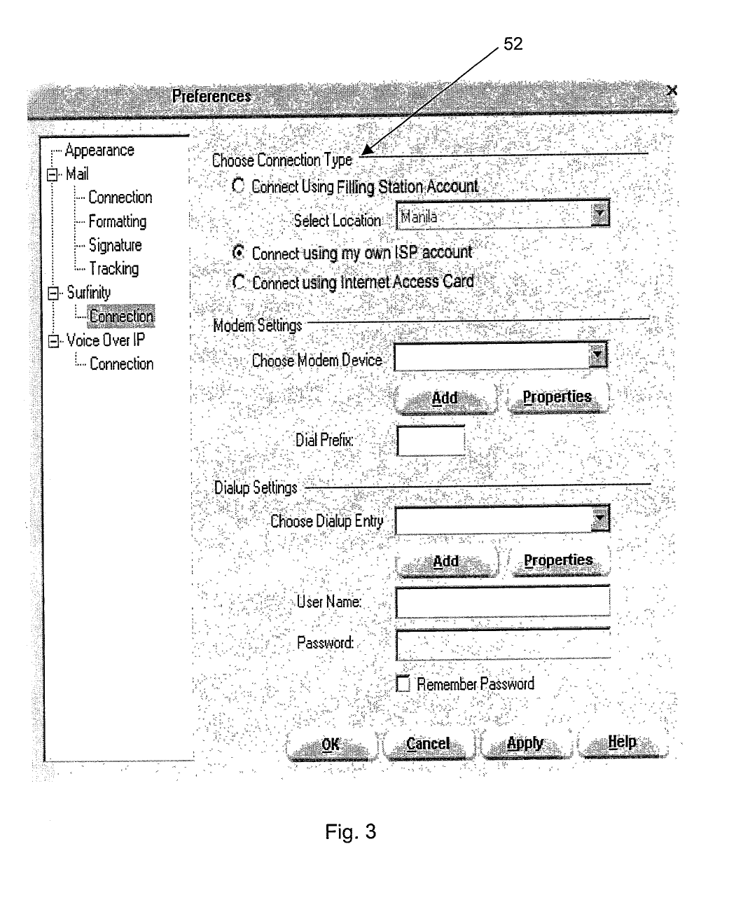

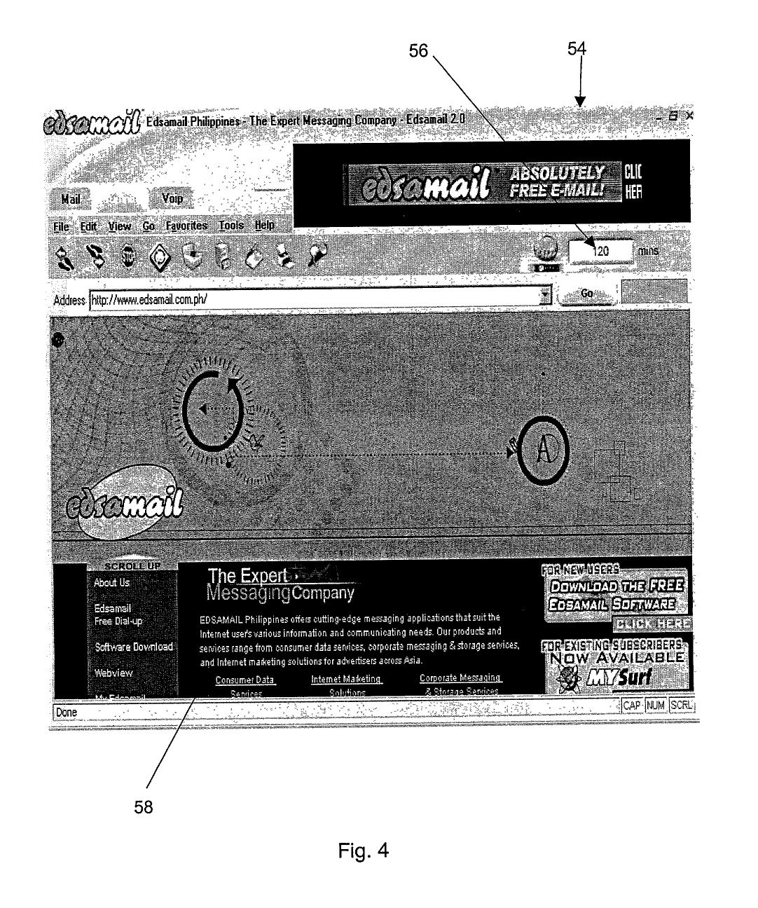

Referring to FIGS. 2-4, after opening the Filling Station software installed on the computer, the user clicks on a surf icon/tab on a menu bar 50. This action activates a pop-up window 52 that prompts the user to select to connect to the Internet using (1) an ISP, (2) an access card, or (3) the Filling Station software to dial-up directly to the server (“the Filling Station connection”).

To use the ISP, the user must subscribe to an ISP. If the user selects to connect using the ISP, a pop-up window prompts the user to enter the appropriate data, such as username, password, and dial-up number. The Filling Station software will then attempt to connect to the ISP using the data entered.

Once the Internet connection is established using the ISP, the user may choose to visit any sponsor's web site. The sponsor's web site includes an area to obtain the amount of free time. When the user clicks on the area to obtain the amount of free time, a pop-up window may appear which prompts the user to enter information requested by the sponsor, for example, name, e-mail address, business address, and telephone number. Once the user submits the information, the information is logged into the database and an amount of free Internet access time is allocated to the corresponding user account. A pop-up results window is then displayed showing the amount of free Internet access time allocated to the user.

To access the Internet for the use of the amount of free Internet access time, the user must establish a separate Internet session using the Filling Station connection. The user may select to increase the amount of free Internet access time through the process discussed below. The server may limit the amount of free Internet access time allocated to one or more users, the amount of additional free Internet access time that may be allocated, or a number of times additional free Internet access time can be added in a specified time period for a user account.

To use an access card, the user must have the access card and retrieve information from the access card. Access cards are distributed by (1) sponsors and/or (2) other sources. Typically, the information on the access card is initially hidden by an opaque protective coating. To view the information, the protective coating must be removed from the access card (e.g., “scratched off”).

If the user selects to connect using a Sponsored Access Card, a pop-up window prompts the user to enter the information printed on the Sponsored Access Card. The dialer within the Filling Station software will then initiate the dial-up connection and connect to the server. The server authenticates the entered information by searching the database for the user account containing the username and password. If found, the server provides an Internet session and allocates to the session the amount of free Internet access time associated with the user account.

If the user selects to connect using a pre-paid access card (i.e., a card not from a sponsor), a pop-up window prompts the user to enter the information printed on the access card. The dialer within the Filling Station software will then connect to a server indicated by the information printed on the access card.

Once the Internet connection is established using the information on the pre-paid access card, the user may choose to visit any sponsor's web site. The web site includes an area to obtain the amount of free Internet access time. When the user clicks on the area to obtain the amount of free Internet access time, a pop-up window may appear and prompt the user to enter information requested by the sponsor, for example, name, e-mail address, business address, and telephone number. Once the user submits the information, the information is logged into the database and an amount of free Internet access time is allocated to the corresponding user account. A pop-up results window is then displayed, showing the amount of free Internet access time allocated to the user. To access the Internet for the use of the amount of free Internet access time, the user must establish a separate Internet session using the Filling Station connection. The user may select to increase the free Internet access time by the process discussed below. The server may limit the amount of free Internet access time allocated to one or more users, the amount of additional free Internet access time that may be allocated, or a number of times additional free Internet access time can be added in a specified time period.

If the user selects to connect to the Internet using the Filling Station connection, a two-stage authentication process is used. In the first stage, the dialer within the Filling Station software connects to the server, that is, the dialer uses Remote Access Services (RAS) to connect and establish a point-to-point protocol (PPP) session. The server authenticates the computer using a username and password that is provided by the user. In the second stage, after the PPP session has been established, the Filling Station software automatically issues a query containing the username and password of the user to the server for a secondary authentication. Once the query is received and the username and password are located in the database, an Internet session is established. The server allocates the amount of free Internet access time associated with the user's account to the Internet session. If the query is not received, such as when a user attempts to connect and use the free Internet access time without the use of the Filling Station software, the user will be disconnected from the Internet.

Once an Internet session is established for the user, the user may begin to surf the Internet though a browser window 54. If the user connects to the Internet through the Filling Station software, the amount of free time available to the user 56 is displayed on the browser window 54. The Filling Station software provides areas 58 that link to sponsors' web sites. The areas that link to sponsors' web sites may be keyed to web sites that would be of particular interest to the user based on the user's profile.

Preferably, if the Internet session is the first session by the user or if the amount of free Internet access time associated with the user's account has been depleted, the user will be provided Internet access for a specified amount of limited time, for example, five minutes. During this limited time, only sponsors' web sites where the user has the option to add additional free Internet access time are accessible. The server tracks an amount of used time that the user is accessing the Internet. If the user does not select to add an amount of additional time, then the server discontinues providing Internet access to the user when the amount of used time equals the amount of free Internet access time. If the user chooses to visit a sponsor's web site and retrieve additional free Internet access time, full Internet access (i.e., for browsing/surfing) is provided to the user until the amount of used time equals the amount of free Internet access time (i.e., until the amount of free time is depleted).

If the Internet session is not the first session by the user or if there is an amount of free Internet access time available, the user is provided with full Internet access for the amount of free Internet access time available. Once full Internet access is provided, the server tracks the amount of used time that the user is accessing the Internet. When the amount of used time equals the amount of free Internet access time, the server discontinues providing Internet access to the user.

The server may prompt the user when the amount of used time is approaching being equal to the amount of free Internet access time, that is, when the amount of free Internet access time is about to run out. The prompt may provide an option to increase the amount of free Internet access time.

At any time during the Internet access, the user may visit any sponsor's web site, for example, by clicking on a link located on the Filling Station software or the software's browser, such as an advertisement, or by entering the Uniform Resource Locator (URL) of a sponsor's web site. Once at a sponsor's web site, an area (e.g., an icon, logo, banner, or link) to obtain the amount of additional free Internet access time is displayed and indicates the amount of additional free Internet access time obtainable. The additional amount of free Internet access time is sponsored by the owner and/or promoter of the web site. If desired, the user clicks on the area to request that the amount of additional free Internet access time be added to the user's account. In some cases, the user may need to view the sponsor's web site or respond to a specific call for action (e.g., fill out a survey) in order to obtain the amount of additional time.

The area to obtain the amount of additional time has codes embedded in the link. When the area is clicked, the Filling Station software parses the codes and sends them to the server as a request for additional free Internet access time. The server processes the codes and, if done successfully, allocates the amount of additional free Internet access time to the user's account. A pop-up message may inform the user that the amount of free Internet access time has been increased. The amount of additional time may take effect when the user next accesses the system or immediately. Preferably, the area to obtain the amount of additional free Internet access time is not accessible to users visiting the web site who do not have the Filling Station software. In such case, the user may be redirected to a web site that explains that the free Internet access time is only available using the Filling Station software and/or provides information about the system.

Other preferred embodiments of systems for providing users with free access to the Internet are similar to the above described embodiment, however, without the Filling Station software. Two such embodiments are a physical embodiment and a virtual embodiment.

In the physical embodiment or a minutes redemption system, Sponsored Access Cards (discussed above) are sponsored and distributed by the sponsor. Each card has a corresponding amount of free time. A unique set of username, password, serial number, and telephone number are printed on each Sponsored Access Card, along with the sponsor's URL.

From any computer having a dialup/browser application, the user enters the username, password, and telephone number from the Sponsored Access Card to establish a connection with the server. The Sponsored Access Card may include instructions for establishing the connection. The user must visit the sponsor's web site within the initial free Internet access time assigned to the Sponsored Access Card using the URL stated on the Sponsored Access Card in order to obtain an amount of additional free Internet access time. The amount of additional free Internet access time available depends on the sponsor who is sponsoring the Sponsored Access Card.

From the sponsor's web site, the user may click on an area to obtain the amount of additional free Internet access time. The user must re-enter the username and password, preferably in a pop-up window, and submit the username and password to the server. The server receives and validates the username and password. The username and password must be valid and must correspond to the sponsor's web site from which the request for the additional amount of time was sent. If the validation is successful, the server allocates the appropriate amount of additional time to the user. The system may inform the user that the amount of additional free Internet access time has been added to the initial amount of free Internet access time. The amount of additional time may be effective upon the next time the user establishes a connection with the system or immediately. The Sponsored Access Card may be limited in the number of times the card can have an amount of additional free Internet access time applied or the number of times additional free Internet access time can be added in a specified time period.

In the virtual embodiment or a minutes distribution system, the user attains an amount of free Internet access time without the use of a Sponsored Access Card. From any computer having a dialup/browser application, the user establishes an Internet connection through an ISP or a pre-paid access card. The user then visits any sponsor's web site. The web site includes an area to obtain the amount of free Internet access time. When the user clicks on the area to obtain the amount of free Internet access time, a pop-up window may appear which prompts the user to enter information requested by the sponsor, for example, name, e-mail address, business address, and telephone number. Once the user submits the information, the information is logged into the database and a pop-up window is displayed. The pop-up results window displays a set of access codes (i.e., a serial number, a username, a password, a dialup number, and an expiration date) and an amount of free Internet access time.

To access the Internet for the amount of free Internet access time, the user must establish a separate Internet session using the provided access codes (i.e., the dialup number, username, and password) prior to the expiration date. The user may select to increase the free Internet access time by adding an amount of additional time as discussed in the preceding paragraphs. The server may limit the amount of free Internet access time allocated to one or more users, the amount of additional free Internet access time that may be allocated, or a number of times amounts of additional free Internet access time can be added in a specified time period.

It will be understood by those skilled in the art that while the foregoing description sets forth in detail preferred embodiments of the present invention, modifications, additions, and changes might be made thereto without departing from the spirit and scope of the invention.

I claim:

1. A method for providing Internet access, comprising the steps of:
receiving at a server information about a user;
searching a database for the information;
allocating to the user an amount of free Internet access time associated with the information, if the information is found in the database;
providing to the user access to the Internet;
tracking an amount of used time the user is accessing the Internet; and
discontinuing access to the Internet when the amount of used time equals the amount of free time.

2. The method for providing Internet access as claimed in claim 1, further including the steps of:
providing the user with an option to increase the amount of free Internet access time;
receiving a request to use the option to increase the amount of free Internet access time issued by the user; and
adding an amount of additional time to the amount of free Internet access time.

3. The method for providing Internet access as claimed in claim 1, further including the steps of:
providing on a sponsor's web site an area where the user can request an amount of additional free Internet access time;
receiving from the sponsor's web site the request for the amount of additional free Internet access time issued by the user; and
adding the amount of additional free Internet access time to the amount of free Internet access time.

4. The method for providing Internet access as claimed in claim 1, further including the step of:
prompting the user when the amount of used time is a predetermined distance from the amount of free Internet access time.

5. The method for providing Internet access as claimed in claim 1, further including the step of:
providing software to the user for installation on the computer, wherein the software allows the user to enter the information and sends the information to the server.

6. The method for providing Internet access as claimed in claim 5, further including the step of:
distributing the software to the user.

7. The method for providing Internet access as claimed in claim 5, further including the step of:
saving a user profile.

8. The method for providing Internet access as claimed in claim 7, further including the step of:
providing on a browser an area to access the sponsor's web site, wherein the sponsor's web site indicated by the area is based on the user's profile.

9. The method for providing Internet access as claimed in claim 5, further including the step of:
providing on the software or a browser within the software an area to access the sponsor's web site.

10. The method for providing Internet access as claimed in claim 5, further including the step of:
distributing an access card to the user, wherein the access card includes the information.

11. The method for providing Internet access as claimed in claim 5, further including the steps of, prior to receiving information about the user:
receiving at the server a request for establishing a connection to the server, wherein the request includes the information;
searching the database for the information; and
establishing the connection to the server if the information is found in the database.

12. The method for providing Internet access as claimed in claim 2, further including the step of:
limiting the access to the Internet to sponsors' web sites until the user requests an amount of additional free Internet access time.

13. The method for providing Internet access as claimed in claim 1, further including the step of:
distributing an access card to the user, wherein the access card includes the information and a Uniform Resource Locator (URL) corresponding to a sponsor's web site.

14. The method for providing Internet access as claimed in claim 13, further including the steps of:
receiving the sponsor's URL after access to the Internet is provided;
directing the user to the sponsor's web site;
providing on the sponsor's web site an area where the user can request an amount of additional free Internet access time;
receiving from the sponsor's web site the request for the amount of additional free Internet access time issued by the user and the information entered by the user; and
adding the amount of additional free Internet access time to the amount of free time if the information is found in the database.

15. A method for providing Internet access, comprising the steps of:
providing on a sponsor's web site an area where a user can request an amount of free Internet access time;
receiving data entered by the user in response to questions; and
providing access codes to the user, wherein the access codes include a username, a password, and a telephone number, wherein the username, password, and telephone number are used by the user to connect to a server and receive access to the Internet for an amount of free Internet access time associated with the access codes.

16. The method for providing Internet access as claimed in claim 15, further including the steps of:
providing the user with an option to increase the amount of free Internet access time;
receiving a request to use the option to increase the amount of free Internet access time issued by the user; and
adding an amount of additional free Internet access time to the amount of free Internet access time.

17. The method for providing Internet access as claimed in claim 15, further including the step of:
providing software to the user for installation on a computer, wherein the software aids the user in accessing the sponsor's web site.
